(19) United States
(12) Patent Application Publication
(10) Pub. No.: US 2012/0204439 A1
(43) Pub. Date: Aug. 16, 2012

(54) HEATER FOR BULK LOAD CONTAINER VEHICLE

(76) Inventor: Michael KLOEPFER, Delhi (CA)

(21) Appl. No.: 13/327,201

(22) Filed: Dec. 15, 2011

Related U.S. Application Data
(60) Provisional application No. 61/441,479, filed on Feb. 10, 2011.

(51) Int. Cl. F26B 25/06; F26B 25/00; F26B 23/10

(52) U.S. Cl. 34/218; 237/28; 34/201; 34/235; 34/242

(57) ABSTRACT

A heating apparatus for a vehicle having a chassis and a bulk load container mounted on the chassis. The apparatus includes a heating chamber for receiving the chassis, a heat source connected to the heating chamber for supplying heated gas to the chamber and a seal mounted to the heating chamber for substantially sealing the heating chamber about the chassis and the container, for guiding the heated gas along a floor and sides of the container to heat the container floor and sides.

### CROSS REFERENCE TO RELATED APPLICATIONS

This application claims the benefit of priority of U.S. Provisional Patent Application No. 61/441,479 filed Feb. 10, 2011, the contents of which is incorporated herein by reference.

### FIELD OF THE INVENTION

The present invention relates generally to vehicle heaters. More particularly, the present invention relates to a heater arrangement for thawing bulk materials frozen into a bulk load container of a vehicle.

### BACKGROUND OF THE INVENTION

The freeze and thaw cycles common during the winter months in the Northern United States and in Canada provide a number of challenges to bulk commodity haulers. Trucks and trailers used for the transportation of loose and moist materials such as sand or soil etc. in countries where the temperature drops below the freezing point, encounter unloading problems when the moist materials freeze on the walls and floor of the trailer and become hard to unload.

The transport of bulk goods during freeze/thaw cycles in commodity haulers such as walking floor trailers, belt clean-out trailers and the like is associated with weather related challenges. When the materials transported in the trailer freeze onto the moving slats, the moving slats may break and/or jam, leading to damage of the driving mechanism that operates them. The common solution to this problem is to drive the trailers into warm buildings and to wait for the frozen materials to thaw. In addition to the provision of a complete building being an expensive solution, it is just not possible to install a heated building at each unloading site. Moreover, this solution is very slow, since the heat supplied is absorbed not only by the bulk goods container, the only structure which needs to be heated, but many other structures, such as the trailer chassis and the whole truck and, of course, the whole building. Only a fraction of the supplied heat energy reaches the walls and floor of the bulk goods container. Also, a substantive amount of heat is lost to the atmosphere while the trailer is driven in and out of the building.

In dump trucks or dump trailers, if wet material is loaded and the ambient temperature is below the freezing point, the material will turn cold and freeze to the bed or bulk load container. In particular, the material will first freeze to the front and sidewalls and then to the floor, due to cooling by the slipstream while the truck is moved. Of course, not all the material will freeze at the same rate and normally the material will not freeze into a block before the destination is reached. The material will freeze to the side walls and the floor at different rates and to different degrees, so that when the dump is raised, bulk material stays stuck to the walls and floor. The freezing starts high on the side walls. The frozen material remains after dumping of the container, making the truck unstable. Also, the bulk material may end up being frozen more to one side of the trailer so that one side of the load will stay while the other side of the load will slip out during dumping. If the situation is not addressed or not detected, the vehicle may actually tip over in a turn, due to the high, unbalanced load. There have been many fatalities over the years because of unevenly loaded trailers tipping over. Sometimes only the trailer tips, but often both trailer and engine tip over, with possibly disastrous results. This problem is sufficiently well known and has a recognized effect on insurance premiums for bulk commodity haulers.

Truck dumpers and dump trailer bodies are known which include arrangements for heating the walls or floor of the truck bed, such as channels for hot exhaust gases from the engine or heated air from integrated or external heating arrangements. Although those arrangements assist in preventing the bulk goods from freezing to the walls and floor of the dumper, they are only effective at temperatures close to freezing and the same problems and dangers as discussed above are encountered at temperatures significantly below freezing.

It is, therefore, desirable to provide a more efficient and effective method for thawing frozen materials transported in a bulk goods container prior to unloading.

### SUMMARY OF THE INVENTION

It is an object of the present invention to obviate or mitigate at least one disadvantage of previous arrangements for heating a truck.

In a first aspect, the present invention provides a heating apparatus for a trailer having a chassis and a bulk load container mounted on the chassis, the apparatus comprising a heating chamber for receiving the chassis, a heat source connected to the heating chamber for supplying heated gas to the chamber, and a seal mounted to the heating chamber for substantially sealing the heating chamber about the chassis and/or the container. The seal is preferably in the form of a plurality of flip-up seal panels rotatably attached to a top edge of the heating chamber walls. Alternatively, the seal is stationary on the walls and the walls are moveable to and from the chassis or the container to achieve sealing engagement of the seal with the chassis or the container.

In a further embodiment of the heating apparatus, the heating chamber is a drive-in chamber for permitting backing of the trailer into the chamber. Preferably, the drive-in heating chamber includes a floor, an end wall connected to an end of the floor and a pair of opposite side walls connected to opposite ends of the back wall and opposite sides of the floor, one of the walls being connected to the heat source for permitting passage of the heated gas across the wall and into the chamber, the end of the chamber which is opposite the end wall being open to allow entry of the trailer chassis into the chamber.

In another preferred embodiment, the heating chamber is a flip-up chamber erectable about the chassis, wherein the side walls are rotatably hinged to the floor. A heating apparatus with flip-up side walls allow the heating chamber to be used in space constrained areas where insufficient space is available for the trailer to be completely aligned with the chamber floor before entering the chamber. Having the side walls flipped down will allow the trailer to be directed into the chamber at an angle and only aligned with the floor once fully backed up against the end wall.

In another preferred arrangement, either in erect or flip-up configuration, the end wall is rotatalbly hinged to one of the side walls or to a stationary corner post mounted in a corner of the floor to allow swiveling of the end wall to a side. This allows the vehicle to be driven into the chamber in reverse when the end wall is in place, or in forward direction when the end wall is swiveled to the side. In the flip up configuration, this arrangement can also include 4 corner posts mounted to the corners of the floor and side walls which are either hinged to the floor or hinged to one of the corner posts. The side walls can also be divided into two or more sections individually hinged to the floor or the corner posts.

The heating apparatus may be stationary or portable. The portable heating apparatus can be of a fully assembled unitary construction, or can be in the form of a kit. The kit preferably includes an end wall connectable with the heat source for permitting passage of the heated gas through the end wall and a pair of sidewalls connectable to opposite ends of the back wall. More preferably, the kit further includes a floor panel to which the side and end walls are connectable. Most preferably, the floor panel is made of inter-connectable panels in order to facilitate assembly and tear down of the arrangement and transport from location to location.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a side and end elevational view of a permanently installed drive-in type heating apparatus;

FIG. 2 is a side and end elevational view of a portable the heating apparatus in accordance with the invention;

FIG. 3 is a perspective open end view of the portable drive-in type heating apparatus of FIG. 2;

FIG. 4 is the side and end elevational view of the heating apparatus of FIG. 2 with a trailer placed in the heating chamber;

FIG. 5 is a perspective view from within the heating chamber illustrating a trailer being reversed into the heating apparatus of FIG. 2;

FIG. 6 is a vertical cross-section taken through FIG. 2 at line 6-6;

FIG. 7 is a perspective open end view of the portable drive-in type heating apparatus of FIG. 2 in a flip-up configuration;

FIG. 8 is a side and end elevational view of the portable heating apparatus of FIG. 2 in a drive-through configuration with a movable end wall;

FIG. 9 is a photograph of a portable heating apparatus in accordance with the invention, taken from the drive-in end of the heating chamber and illustrating the flip-up seal panels in the upright position;

FIG. 10 is a photograph of the apparatus of FIG. 8, taken from outside the heating chamber and showing the right side chamber wall and right side seal walls; and

FIG. 11 is a photograph of the apparatus of FIG. 8 taken from outside the heating chamber and showing the chamber end wall and heat source.

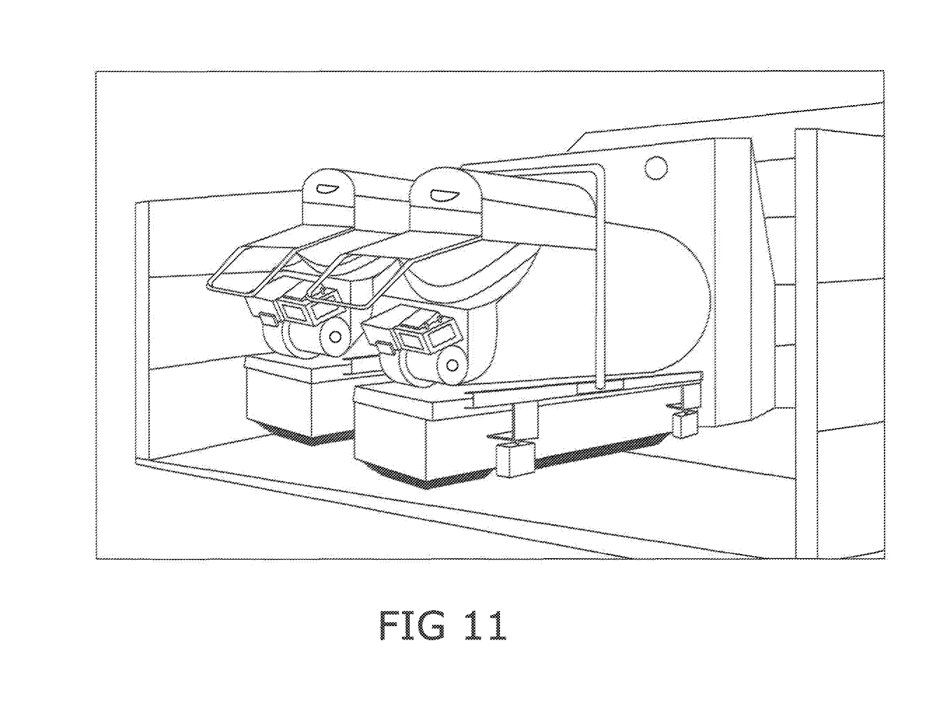

### DETAILED DESCRIPTION

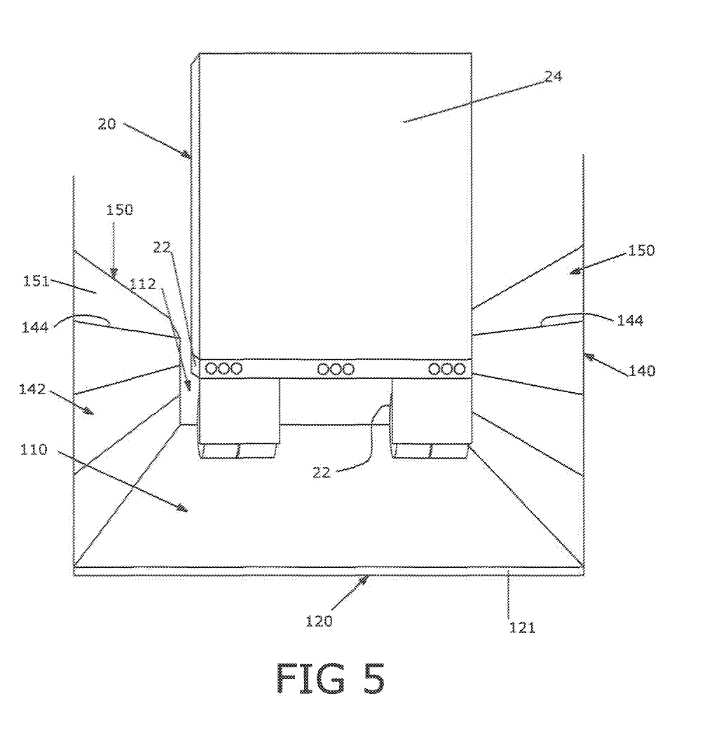

Generally, the present invention provides a method and system for thawing bulk materials frozen to a truck bulk load container or a trailer bulk load container. More particularly, the invention provides a heating apparatus 100 for a vehicle 20 having a chassis 22 and a bulk load container 24 mounted on the chassis 22 (see FIG. 5).

A heating apparatus 100 in accordance with the invention and as illustrated in the Figures, includes a heating chamber 110 for receiving the chassis 22, a heat source 200 connected to the heating chamber 110 for supplying warmed up heating gas to the chamber, and a seal 150 mounted to the heating chamber 110 for substantially sealing the heating chamber 110 around the chassis 22 and/or the container 24, when the vehicle 20 is in the chamber 110, while leaving an exhaust opening for spent heating gas, preferably at an end of the chamber opposite the location of the heat source.

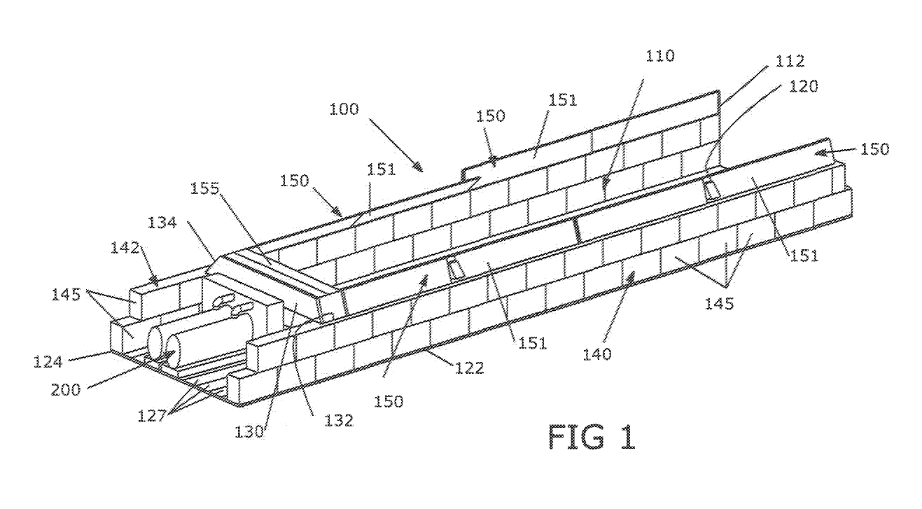

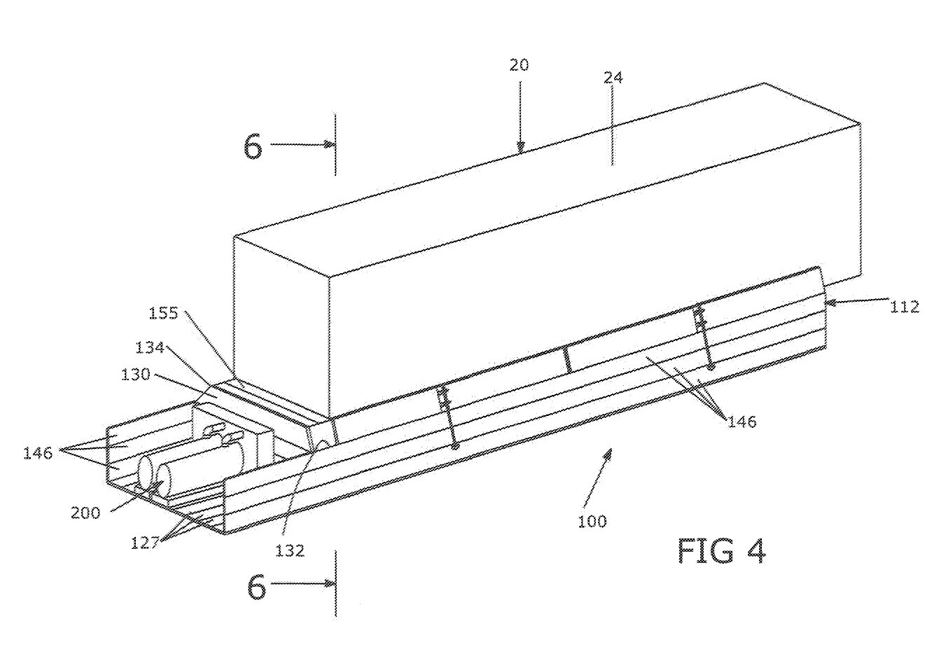

In the basic embodiment, as illustrated in FIG. 1, the heating apparatus 100 includes a drive-in heating chamber 110, which means a chamber, which allows the backing of the vehicle 20 into the chamber (see FIG. 4). The preferred drive-in chamber 110 includes a floor 120, an end wall 130 positioned on the floor 120 and a pair of opposite side walls 140, 142 connected to opposite sides 132,134 of the end wall and also positioned on the floor 120. One of the walls 130, 140, 142 is connected to the heat source 200 for permitting passage of the heated gas across the wall and into the chamber 110. The floor may be naturally occurring or man made supporting surface at the point of installation of the apparatus.

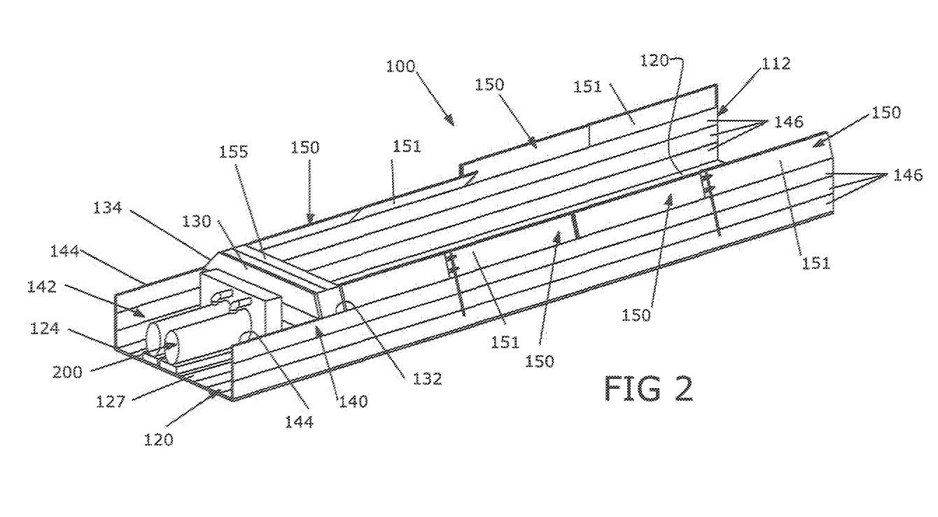

In a preferred embodiment as illustrated in FIG. 2, the heating apparatus 100 includes the drive-in heating chamber 110, the floor 120 is in the form of a base panel 121, in the illustrated embodiment made of a plurality of interconnected panels 127, the end wall 130 is connected to the base panel 121 and the pair of opposite side walls 140, 142 are connected to opposite sides 132, 134 of the end wall and also connected to the base panel 121 along opposite sides 122, 124 of the panel. One of the walls 130, 140, 142 is connected to the heat source 200 for permitting passage of the heated gas across the wall and into the chamber 110. Preferably the heat source 200 is connected to the end wall 130 and the opposite end of the chamber 110 is open to allow entry and exit of the vehicle as well as exhausting of the spent heating gas. By placing the heat source 200 and the exhaust opening at opposite ends of the heating chamber 110, the residence time of the heating gas in the chamber is maximized.

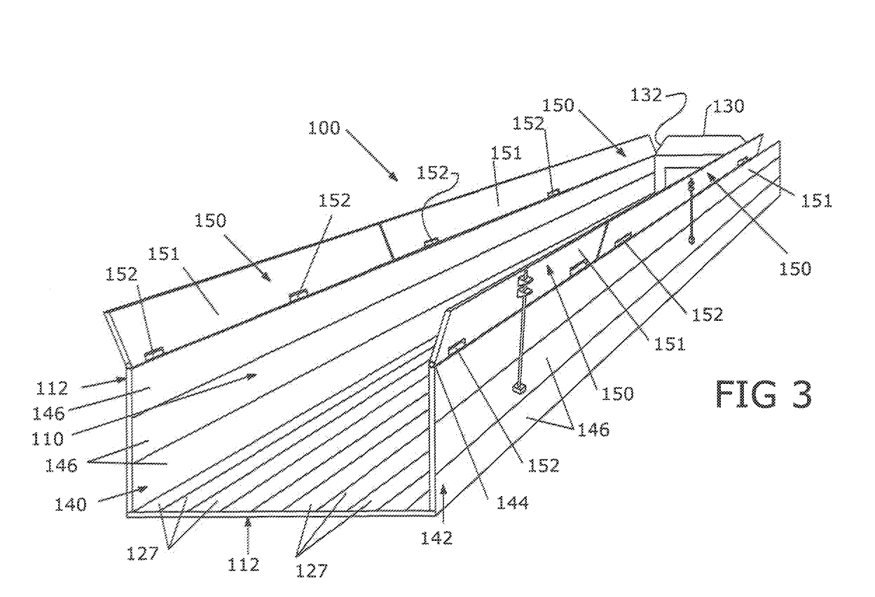

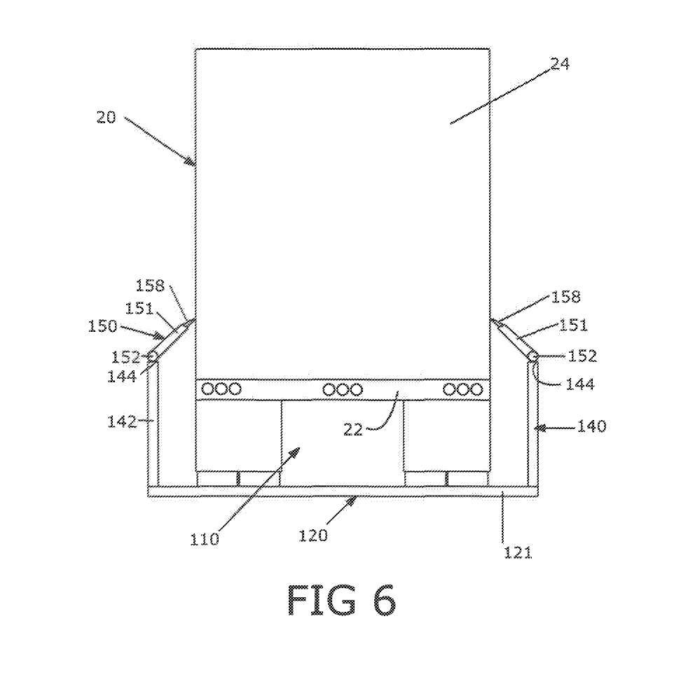

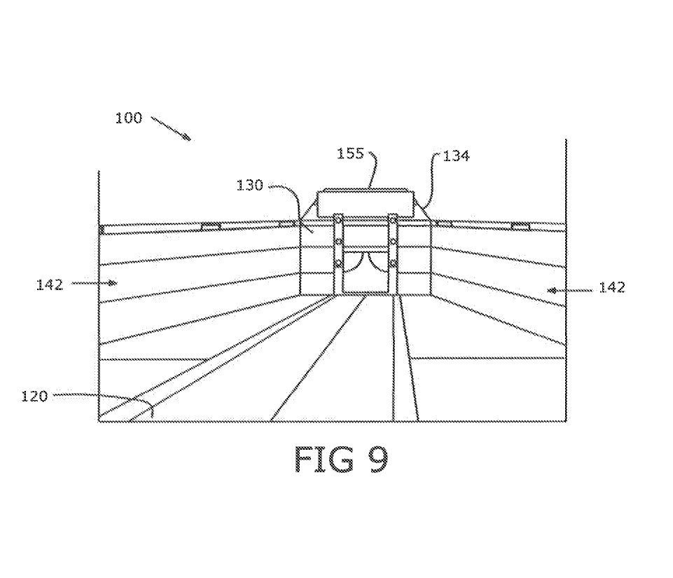

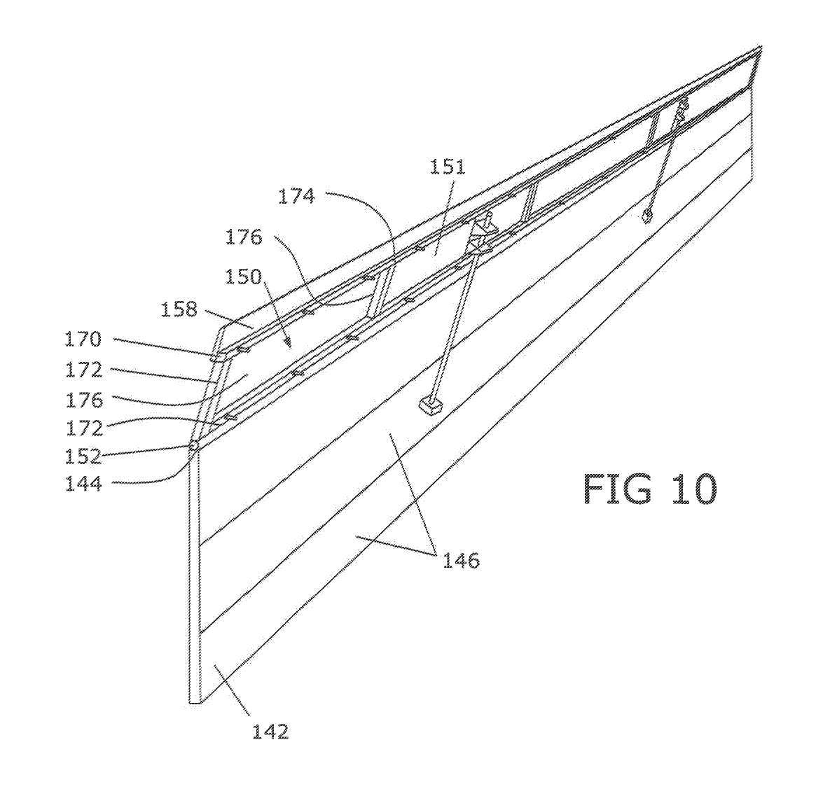

In the embodiments illustrated in the Figures, the heat source 200 is a pair of conventional combustion heaters (oil, gas, etc.) attached to the end wall 130. An end 112 of the chamber 110 opposite the end wall 130 is open to allow entry of the vehicle chassis 22 into the chamber 110 (see FIG. 5). In the embodiment illustrated in FIG. 2, the seal 150 is mounted to a top end 144 of the side walls 140, 142. The seal 150 is preferably a rigid seal panel 151 rotatably mounted to the top end 144 by hinges 152 (see FIG. 3) to permit movement of the seal panel between a sealing position wherein a free edge 153 of the seal panel 151 engages the chassis 22 or the container 24 (see FIGS. 4 and 6) and an open position wherein the seal 150 is pivoted away from the chamber 110 to permit entry of the vehicle 20 into the chamber 110 (see FIG. 5). The seal 150 may be constructed as one or more rigid panels or as a frame structure with sheet like covering material (see FIGS. 9 and 10). In another embodiment (not illustrated), the seal is rigidly affixed to the side walls and the end wall and the side walls are movably attached to the floor to allow pivoting of the side walls to move the seal between the open and sealing positions.

The seal 150 may also be mounted to the top end 144 by any other attachment structure, such as flexible or elastic structures or webs, such as a living hinge, which allow the seal panels to be swiveled about the top end 144 between the sealing and open positions. Moreover, any other seal structure which is movable between the open and sealing positions can be used, as long as the seal structure in the open position does not impede the positioning of the vehicle into the heating chamber and in the sealing position is in a sealing engagement with the chassis and/or the container to impede heating air from escaping therebetween. For example, the seal can be moved in between the open and sealing positions in a manner other than rotationally, such a linear, for example by way of sliding tracks mounted on the outside of the side walls (not shown).

The heating apparatus 100 can be portable as illustrated in FIG. 2 or permanently installed as illustrated in FIG. 1. In a permanently installed heating chamber 110 as shown in FIG. 1, which may optionally include a base panel 121, the side walls 140, 142 are made of stacked blocks 145, such as concrete or masonry blocks, preferably insulated blocks. Heating chambers can be built as rigid chambers or as a flip-up chamber erectable about the chassis and the container. The chamber can also be provided in the form of a kit to improve portability and to allow modification of the chamber size. When the heating chamber is in the form of a kit, the kit preferably includes the heat source, an end wall connectable with the heat source for permitting passage of the heated gas, a pair of sidewalls connectable to opposite ends of the back wall, the seal and hardware to connect the heat source to the end wall and the side walls to the end wall. The kit may further include a floor panel for supporting the end wall the side walls and the heat source and hardware to connect the walls and the heat source to the floor panel.

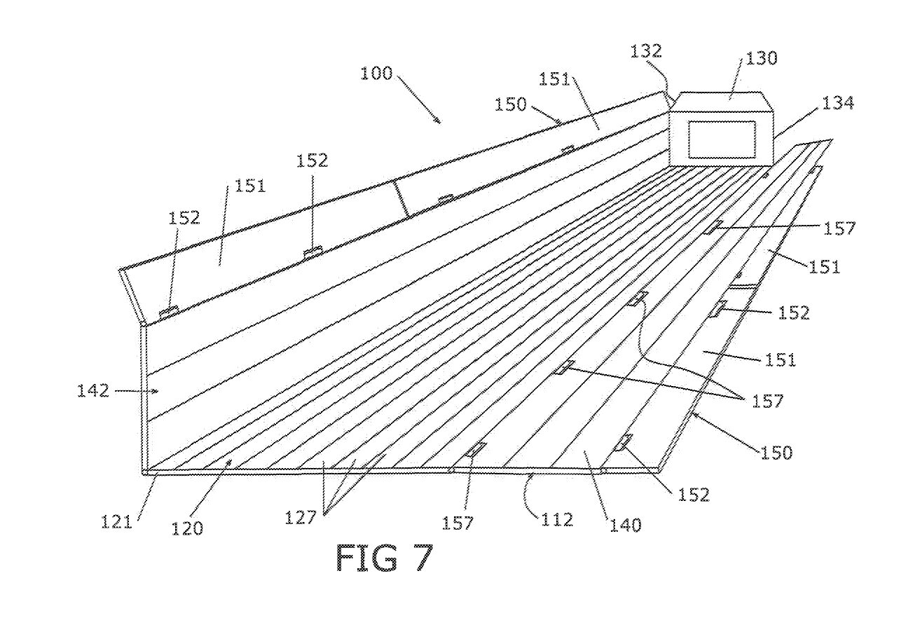

The heating apparatus 100 can also be constructed as a flip-up chamber 110 erectable about the chassis 22. In the flip-up embodiment, at least one of the side walls 140, 142 is rotatably hinged to the floor 120 (see FIG. 7) by hinges 157. The flip-up side walls allow the heating chamber 110 to be used in space constrained areas where insufficient space is available for the vehicle 20 to be completely aligned with the chamber floor 120 before entering the chamber 110. Having at least one of the side walls 140, 142 flipped down allows the vehicle 20 to be directed into the chamber at an angle and only aligned with the floor once fully backed up against the end wall.

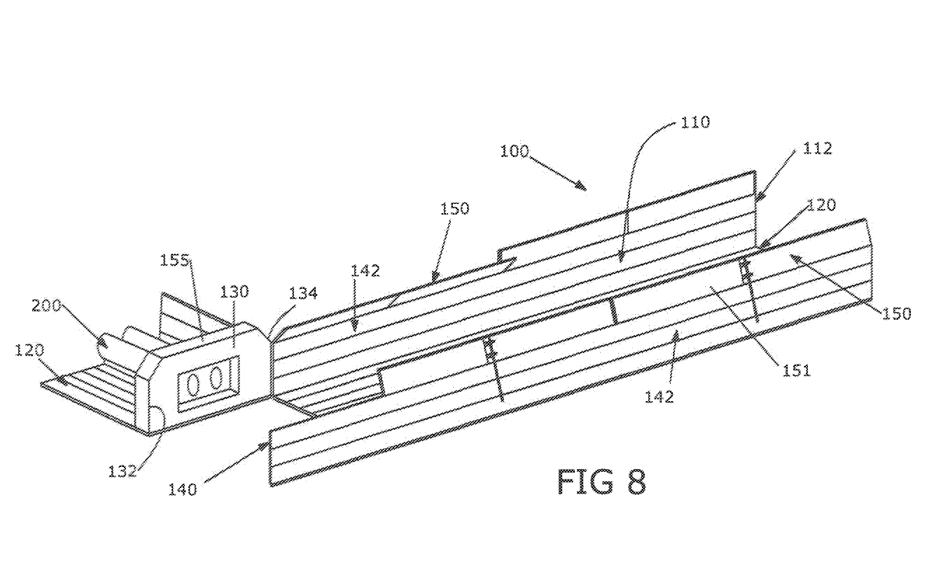

In another preferred arrangement, the heating apparatus 100 is in a drive-through configuration in which the end wall 130 is rotatalbly hinged to one of the side walls 140, 142 (see FIG. 8) or to a stationary corner post 160 mounted in a corner of the floor 120 to allow swiveling of the end wall 130 to a side. This allows the vehicle 20 to be driven into the chamber 110 in reverse when the end wall 130 is in place, or in forward direction when the end wall is swiveled to the side, making it a drive-through chamber. This embodiment can also be made in the flip up configuration, for example by providing 2 corner posts mounted to opposite corners of the end 125 of the floor 120 (not shown), or 4 corner posts mounted to the 4 corners of the floor 120 and by hinging the side walls 140, 142 either to the opposite sides 122, 124 of the floor 120, respectively or to one of the corner posts. The side walls 140, 142 can also be divided into two or more sections individually hinged to the floor 120 or the corner posts (not shown).

The portable heating apparatus 100 can be of a fully assembled unitary construction as shown in FIG. 2 and transportable on a flat bed truck, or can be in the form of a kit (not shown).

The side walls and the floor panel can be unitary panels or can be assembled from subpanels. Preferably the side walls 140, 142 are assembled from subpanels 146, more preferably extruded, hollow aluminum panels welded together along their edges. Preferably, the floor panel 121 is assembled from subpanels 127, more preferably extruded, hollow aluminum panels welded together along their edges. When the heating apparatus is in the form of a kit, the floor panel 121 and the side walls 140 and 142 are preferably made of individual sub panels which are interconnectable for assembly of the apparatus. This will facilitate assembly and tear down of the heating arrangement kit and transport from location to location.

The stationary seal 150 on the end wall is preferably a cushioned seal, more preferably a loading dock cushion 155 that is compressible to avoid damage to the seal when the vehicle is backed into the seal. The seal panels on the sidewalls are preferably divided into two or more sections for ease of handling. The panels preferably have a large rubber flap 158 (see FIG. 6) all the way along for improved sealing engagement with the vehicle. More preferably, the panels are transversely split into multiple sections (three or more sections on each sidewall) so that if the vehicle, once in the chamber 110, is not positioned exactly parallel to the sidewalls 140, 142, an acceptable seal can still be achieved between the panels and the vehicle.

As is apparent from FIG. 10, the seal panels 151 can be made of a metal frame structure 170 including square tube frame pieces 172 welded together to form a rectangular frame 174 with one or more cross braces 176 for added rigidity. The openings defined by the rectangular frame 174 and divided by the cross braces 176 are closed by a flexible sheet 178, such as a fiber reinforced tarp, preferably a heavy duty tarp able to resist the elevated temperatures of the heating gas generated by the heat source 200. The frame 174 is mounted along one longitudinal edge to the top edge 144 of the sidewall 142 by the hinge arrangement 152. A wide rubber lip 158 is bolted to the opposite longitudinal edge, the free edge of the frame, for improved sealing engagement with the vehicle to be heated.

During use of the heating apparatus, the vehicle is backed in between the chamber sidewalls until the vehicle back end hits the loading dock cushion mounted on the chamber end wall and seals the back end from hot air escaping. Then the sealing panels are flipped up and in and come to rest on the bulk load container sides to seal the hot air in.

Once the vehicle is in place and the apparatus sealed against the container, the heat source can now be started up. Any type of heater can be used, but construction heaters are preferred. Construction heaters are robust and suited well for high volume throughput, are easy to use, often have an automatic starter arrangement and an automated fan or blower. Direct fired or indirect heaters can be used, which means the heating flame can go right into the heating chamber with exhaust included (direct fired) or the exhaust can be separate from the heated air (indirect fired). Indirect fired heaters generally include heat exchangers.

The hot gas from the heater flows down through the heating chamber and directly heats the floor and lower sides of the bulk container. Seal panels of different height can be used to reach up higher on the sides of the container, if desired, to heat all of the container sidewalls. After flowing along the container, the spent heating gases are exhausted out the open end of the heating chamber.

Although it is generally only necessary to heat the floor and sidewalls of the bulk load container for the load to release, the chamber sidewalls and the sealing panels can be extended in height for the seal between the sealing panels and the container to occur at the top edge of the container sidewalls. This may be required for applications far north where it may be necessary to heat substantially the whole container.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A heating apparatus for a vehicle having a chassis and a bulk load container mounted on the chassis, the apparatus comprising:
a heating chamber for receiving the chassis,
a heat source connected to the heating chamber for supplying heated up heating gas to the chamber, and
a seal mounted to the heating chamber for substantially sealing the heating chamber about the chassis or the container.

2. The heating apparatus of claim 1, wherein the heating chamber is a drive-in chamber for permitting driving of the trailer into the chamber.

3. The heating apparatus of claim 2, wherein the heating chamber includes a floor, a back wall connected to an end of the floor and a pair of opposite side walls connected to opposite ends of the back wall and opposite sides of the floor, one of the walls being connected to the heat source for permitting passage of the heated heating gas across the wall and into the chamber, an end of the chamber opposite the end wall being open to allow entry of the trailer chassis into the chamber and to provide an exhaust opening for spent heating gas.

4. The heating apparatus of claim 1, wherein the seal is mounted to be movable between a sealing position wherein the seal engages the chassis or the container for sealing the chamber about the chassis or the container and an open position in which the seal is retracted to permit entry and exit of the vehicle.

5. The heating apparatus of claim 4, wherein the side walls are made of one or more connected panels.

6. The heating apparatus of claim 5, wherein the floor is a base panel and the side walls are connected to the base panel.

7. The heating apparatus of claim 6, wherein the base panel is made of one or more connected panels.

8. The heating apparatus of claim 1, wherein the heating chamber is a flip-up chamber erectable about the chassis.

9. The heating apparatus of claim 1, wherein the heating chamber is a chamber kit including an end wall connectable with the heat source for permitting passage of the heated gas and a pair of side walls connectable to opposite ends of the back wall.

10. The heating apparatus of claim 4, wherein the floor is a supporting surface present at a location of installation of the apparatus and the side walls are made of stacked blocks.

11. The heating apparatus of claim 3, wherein the seal includes a first seal portion on the end wall to seal against an end of the vehicle and a second seal portion mounted on the side walls for movement between the sealing and open positions.

12. The heating apparatus of claim 11, wherein the second seal portion includes multiple sealing panels pivotally mounted to the sidewalls for movement between the open position and the sealing position.

13. The heating apparatus of claim 3, wherein the second seal portion includes a sealing panel rigidly mounted to each of the side walls, the side walls being movably mounted for moving the seal between the open and sealing positions.

14. The heating apparatus of claim 11, wherein the first seal portion is cushioned and the sealing panels of the second seal portion include flexible sealing lips for flexible engagement with the chassis or the container.

15. The heating apparatus of claim 2, wherein the heating chamber includes, a back wall and a pair of opposite side walls connected to opposite ends of the back wall, one of the walls being connected to the heat source for permitting passage of the heated heating gas across the wall and into the chamber, an end of the chamber opposite the back wall being open to allow entry of the trailer chassis into the chamber and to provide an exhaust opening for spent heating gas.
